(19) United States
(12) Patent Application Publication
(10) Pub. No.: US 2020/0240205 A1
(43) Pub. Date: Jul. 30, 2020

(54) DOOR ASSEMBLY WITH FLEXIBLE DOOR HAVING AUTOMATICALLY LOCKING BOTTOM BAR

(71) Applicant: McKeon Rolling Steel Door Co., Inc., Bellport, NY (US)

(72) Inventors: Ashraf Gomaa, Stony Brook, NY (US); Andrew C. Lambridis, Dix Hills, NY (US); Oscar Escobar, Glendale, NY (US)

(21) Appl. No.: 16/750,543

(22) Filed: Jan. 23, 2020

Related U.S. Application Data
(60) Provisional application No. 62/796,722, filed on Jan. 25, 2019.

(51) Int. Cl. E06B 9/58; E06B 9/15; E06B 9/17

(52) U.S. Cl. CPC E06B 9/581; E06B 2009/1577; E06B 9/17007; E06B 9/15

(57) ABSTRACT

A door assembly with a flexible door movable between a retracted position and an extended position and having interconnected elongate slats having two lateral ends to form respective lateral edges of the flexible door. An automatically-locking bottom bar connects to a bottom-most slat of the flexible door. The bottom bar has anchors extending from the lateral ends thereof, the anchors extending beyond the respective lateral edges of the flexible door. A pair of guide channels receives the respective lateral edges of the flexible door, each guide channel having a reduced width portion in a bottom portion thereof to receive a respective one of the anchors when the bottom bar passes into the bottom portion of the pair of guide channels, the reduced width portion being laterally spaced from a lateral end of each said guide channel so that the respective anchor is locked in each said guide channel.

### CROSS-REFERENCE TO RELATED APPLICATION

This application claims benefit under 35 U.S.C. § 119(e) of U.S. Provisional application No. 62/796,722, filed Jan. 25, 2019, the entirety of which is incorporated by reference herein.

### BACKGROUND OF THE INVENTION

### Field of the Invention

The present invention is directed to a door assembly with a flexible door, moveable in guide channels, with the flexible door having a bottom bar with anchors extending from the lateral ends thereof to automatically lock the bottom bar in the guide channels when the door is in a closed position.

### Description of the Related Art

Rolling door assemblies include a rolling door horizontally and rotatably arranged within a housing that is positioned at an opening in a wall, such as a doorway. Wrapped about a shutter roll is a flexible door that can be deployed from the shutter roll between an extended position wherein the doorway is closed, and an open position. In the fully deployed and extended position, the leading edge of the door sits parallel with and flush on the ground. The door has lateral edges which are guided along guide channels disposed along a right-side edge and left-side edge of the doorway. The channels receive side edges of the door and act as a guide during deployment of the flexible door and allow the door to be deployed within a “plane of deployment” containing both channels.

The flexible door is typically formed from a plurality of horizontal interlocking parallel metallic slats. The lateral edges of the slats are positioned for movement in the guide. The door has a proximal edge fixed at one end to the shutter roll and a leading opposing free edge connected to a bottom bar. When the door is in a fully extended closed position, the bottom bar is parallel with and in contact with the ground.

FIG. 7 is a perspective view of a prior art manual locking extendable tongue bottom bar 700 in a fully extended position. FIG. 8 is a perspective view of the prior art manual locking extendable tongue bottom bar 700 in an non-extended position. FIG. 9 is a perspective view of the prior art manual locking tongue and slot mechanism in a closed position. The bottom bars 700 of conventional rolling doors are manually secured shut. In particular, once the bottom bar 700 is in contact with the ground, an extendable tongue 710 that is connected to the bottom bar 700 on each end, is manually shifted outward through a slot 720 positioned at the bottom of the guides 730 (see FIG. 9). Once the tongue 710 is extended through the slot 720, a padlock is manually placed through a tab 725 on the extendable tongue 710, and through a corresponding tab 735 fixed to the bar 700, to lock the door in a closed position. The tongue 710 and slot 720 configuration creates drawbacks including, but not limited to, the requirement that a person has to physically extend each tongue 710 through a corresponding slot 720 and then apply a lock to each side. Additionally, given that there are moving metal parts required to fit inside each other, lubricant and other maintenance could be required as an extra step to achieve the proper fit of each extendable tongue 710 through its respective slot 720.

### SUMMARY OF THE INVENTION

A flexible, rolling steel door is disclosed which has the ability to remain in the guide channels until it reaches a fully extended and closed position where a bottom bar is automatically secured. The disclosed embodiments allow for rolling doors to automatically lock, with respect to inward forces against the door, when completely extended through a self-locking arrangement in the bottom bar assembly. The automatic locking mechanism is created through the alignment of the bottom bar locking member with a bottom bar retainer. The bottom bar retainer comprises retaining locking bars which are located inside the guide channels at the base on each end of the rolling door and have one retaining bar on the side of an inner guide angle and one retaining bar on a side of an outer guide angle, leaving a large enough gap there between to accommodate the bottom bar. Each end of the bottom bar has a wide portion, preferably configured as a sideways “T” member, which remains within the outer and inner guide channels while being deployed, but when approaching the ground and the bottom bar retaining locking bars, the T-members align and fit on the outside of the retaining bars in the lateral direction, with the bottom bar continuing through the gap in the middle of the retaining bars. As a result of the automatic locking of the bottom bar, movement of the bottom bar and proximate door slats becomes restricted with respect to the deployment plane of the door, thereby reducing the chance that the door might be forcibly derailed from the guide channels.

The automatic locking mechanism provides improved holding of the rolling door when it is in a closed position and solves the problem of requiring manual manipulation to secure the door in a locked position. Rather than someone having to slide the extendable tongues through the slots, the automatic locking mechanism will secure on its own and protect against inward forces against the door and hold the door in place on its guides. The automatic locking mechanism does not require any additional moving parts, such as an extendable tongue, which limits the possibility for additional required maintenance. As described above, the automatic locking mechanism protects against inward forces on the door and holds the rolling door in its guides. The prevention of lifting of the door, on the other hand, can be achieved by use of any conventional locking mechanism, such as a padlock, as would be understood by those having ordinary skill in the art.

A door assembly to cover an opening of a building may be summarized as including a shutter roller positioned proximate the opening and rotatable about an axis of rotation; a flexible door windable on and off the shutter roller to move between a retracted position and an extended position in which at least a portion of the flexible door lies in a deployment plane to at least partially cover the opening of the building. The flexible door includes a plurality of elongate slats which rotatably interconnect along transverse edges thereof, each of the plurality of elongate slats having two lateral ends to form respective lateral edges of the flexible door; and an elongate bottom bar to connect to a bottom-most slat of the plurality of elongate slats, the bottom bar having anchors extending from the lateral ends thereof, the anchors extending beyond the respective lateral edges of the flexible door. The door assembly further includes a pair of guide channels to receive the respective lateral edges of the flexible door at opposing sides of the opening, each guide channel having a reduced width portion in a bottom portion thereof to receive a respective one of the anchors when the bottom bar passes into the bottom portion of the pair of guide channels, the reduced width portion being laterally spaced from a lateral end of each said guide channel so that the respective anchor is locked in each said guide channel.

The door assembly may include a drive mechanism to rotate the shutter roller about the axis of rotation. Each of the anchors may have a lateral portion extending laterally and a transverse portion at a distal end of the lateral portion and extending perpendicularly to the lateral portion. Each of the anchors may be T-shaped, with the lateral portion being a planar rectangular member which is vertically oriented parallel to the deployment plane and the transverse portion being a planar rectangular member which is vertically oriented perpendicular to the deployment plane. The reduced width portion may receive the lateral portion of the respective one of the anchors when the bottom bar passes into the bottom portion of the pair of guide channels, the reduced width portion being sized and positioned so that the transverse portion of the respective one of the anchors cannot pass through the reduced width portion in a lateral direction, thereby locking the respective anchor in each said guide channel.

Each guide channel may include one or more retaining bars in the bottom portion extending from respective opposing inner side walls thereof to form the reduced width portion. The one or more retaining bars may have a height which is between about a height of the transverse portions of the anchors and about four times the height of the transverse portions of the anchors. The one or more retaining bars may have a height which is between about two times the height of the transverse portions of the anchors and about three times the height of the transverse portions of the anchors.

Each guide channel may include a pair of retaining bars in the bottom portion extending from opposing inner side walls thereof, respective opposing inner edges of the retaining bars having a gap therebetween to form the reduced width portion. The pair of retaining bars of each guide channel may have upper edges which are angled toward the gap to direct the lateral portion of the respective one of the anchors into the reduced width portion as the bottom bar passes into the bottom portion of the pair of guide channels. Each guide channel may include a first elongate angle to attach to the doorway; a second elongate angle to attach to the first elongate angle to form an inner wall of each said guide channel; and a third elongate angle to attach to the first elongate angle to form an outer wall of each said guide channel.

A flexible door is provided which is windable on and off a shutter roller to move between a retracted position and an extended position in which at least a portion of the flexible door lies in a deployment plane to at least partially cover an opening of a building, the opening having a pair of guide channels at opposing sides thereof, each guide channel having a reduced width portion in a bottom portion thereof, the reduced width portion being laterally spaced from a lateral end of each said guide channel. The flexible door may be summarized as including a plurality of elongate slats which rotatably interconnect along transverse edges thereof, each of the plurality of elongate slats having lateral ends to form respective lateral edges of the flexible door, the lateral edges adapted to be received in the pair of guide channels; and an elongate bottom bar to connect to a bottom-most slat of the plurality of elongate slats, the bottom bar having anchors extending from the lateral ends thereof, the anchors extending beyond the respective lateral edges of the flexible door, the anchors adapted to be received in the reduced width portions of the guide channels when the bottom bar passes into the bottom portion of the pair of guide channels so that the anchors are locked in the guide channel.

In implementations of the flexible door, each of the anchors may a lateral portion extending laterally and a transverse portion at a distal end of the lateral portion and extending perpendicularly to the lateral portion. Each of the anchors may be T-shaped, with the lateral portion being a planar rectangular member which is vertically oriented parallel to the deployment plane and the transverse portion being a planar rectangular member which is vertically oriented perpendicular to the deployment plane. The lateral portion of each of the anchors may be received in the reduced width portion of the respective guide channel when the bottom bar passes into the bottom portion of the pair of guide channels, the transverse portion of each of the anchors being sized and positioned so that the transverse portion cannot pass through the reduced width portion of the respective guide channel in a lateral direction, thereby locking each of the anchors in the respective guide channel.

A bottom bar is provided to connect to a flexible door windable on and off a shutter roller to move between a retracted position and an extended position in which at least a portion of the flexible door lies in a deployment plane to at least partially cover an opening of a building, the opening having a pair of guide channels at opposing sides thereof, each guide channel having a reduced width portion in a bottom portion thereof, the reduced width portion being laterally spaced from a lateral end of each said guide channel, the flexible door comprising a plurality of elongate slats which rotatably interconnect along transverse edges thereof, each of the plurality of elongate slats having lateral ends to form respective lateral edges of the flexible door, the lateral edges adapted to be received in the pair of guide channels, the bottom bar includes an elongate body; a hooked transverse edge on an upper surface of the elongate body to rotatably connect to a bottom-most slat of the plurality of elongate slats of the flexible door; and anchors extending from lateral ends of the body, the anchors extending beyond the respective lateral edges of the flexible door, the anchors adapted to be received in the reduced width portions of the guide channels when the bottom bar passes into the bottom portion of the pair of guide channels so that the anchors are locked in the guide channel.

In implementations of the bottom bar, each of the anchors may a lateral portion extending laterally and a transverse portion at a distal end of the lateral portion and extending perpendicularly to the lateral portion. Each of the anchors may be T-shaped, with the lateral portion being a planar rectangular member which is vertically oriented parallel to the deployment plane and the transverse portion being a planar rectangular member which is vertically oriented perpendicular to the deployment plane. The lateral portion of each of the anchors may be received in the reduced width portion of the respective guide channel when the bottom bar passes into the bottom portion of the pair of guide channels, the transverse portion of each of the anchors being sized and positioned so that the transverse portion cannot pass through the reduced width portion of the respective guide channel in a lateral direction, thereby locking each of the anchors in the respective guide channel.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn, are not necessarily intended to convey any information regarding the actual shape of the particular elements, and have been solely selected for ease of recognition in the drawings.

FIG. 1 is a perspective view of a locking bottom bar having anchors extending from the lateral ends thereof, according to at least one illustrated implementation.

FIG. 2 is a front elevation view of a door assembly to cover an opening of a building, according to at least one illustrated implementation.

FIG. 3 is a side sectional view of the door assembly showing a shutter roll arranged within a housing that is positioned over an opening of the building, according to at least one illustrated implementation.

FIG. 4 is a top plan view of the locking bottom bar having anchors extending beyond the respective lateral edges of the flexible door into the guide channels, according to at least one illustrated implementation.

FIG. 5 is a side sectional view of the locking bottom bar having anchors extending from the lateral ends thereof, according to at least one illustrated implementation.

FIG. 6 is an axonometric view of the locking bottom bar of FIG. 5, according to at least one illustrated implementation.

FIG. 7 is a perspective view of a prior art manual locking extendable tongue bottom bar in a fully extended position.

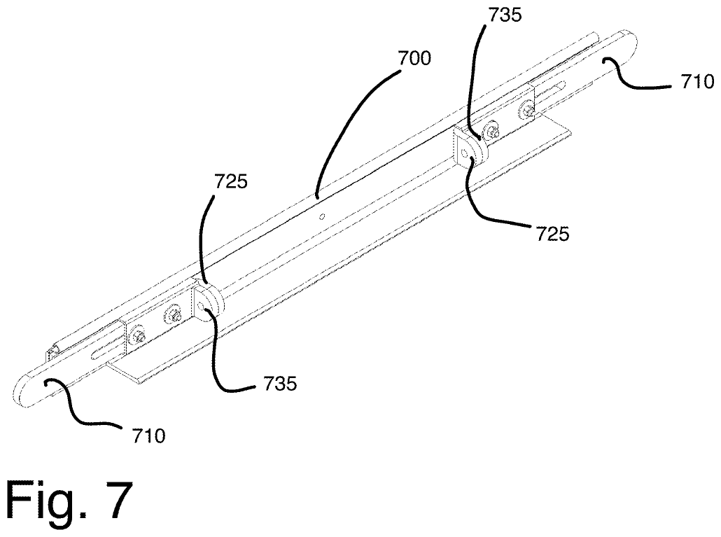

FIG. 8 is a perspective view of the prior art manual locking extendable tongue bottom bar in an non-extended position.

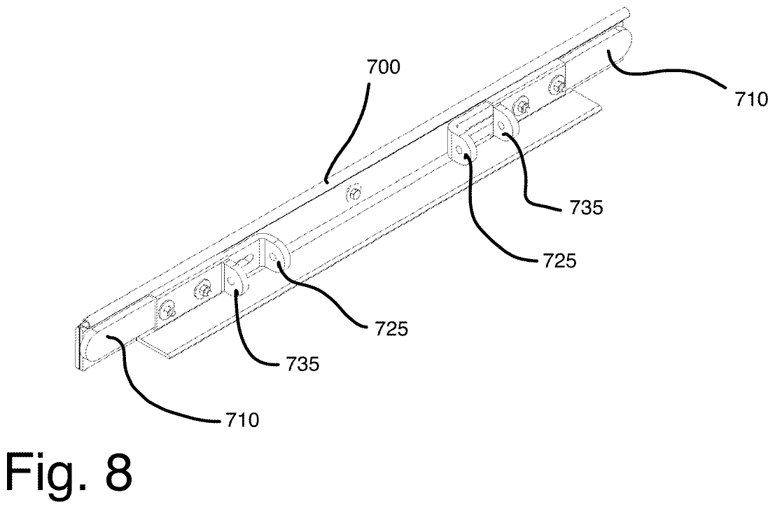

FIG. 9 is a perspective view of the prior art manual locking tongue and slot mechanism in a closed position.

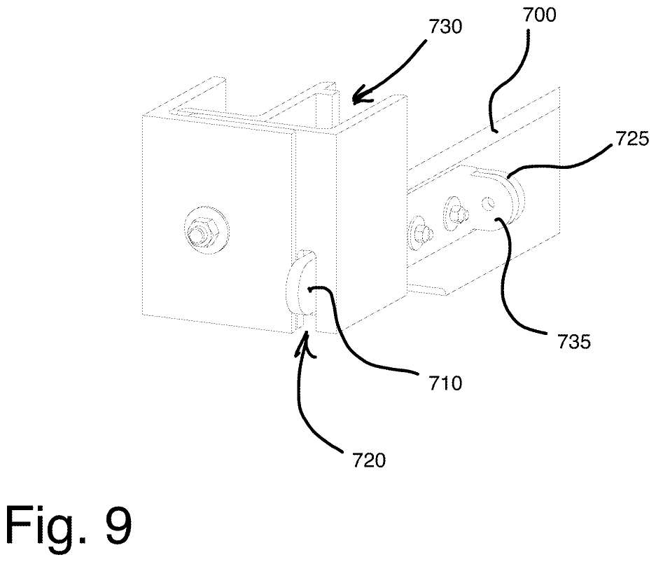

### DETAILED DESCRIPTION

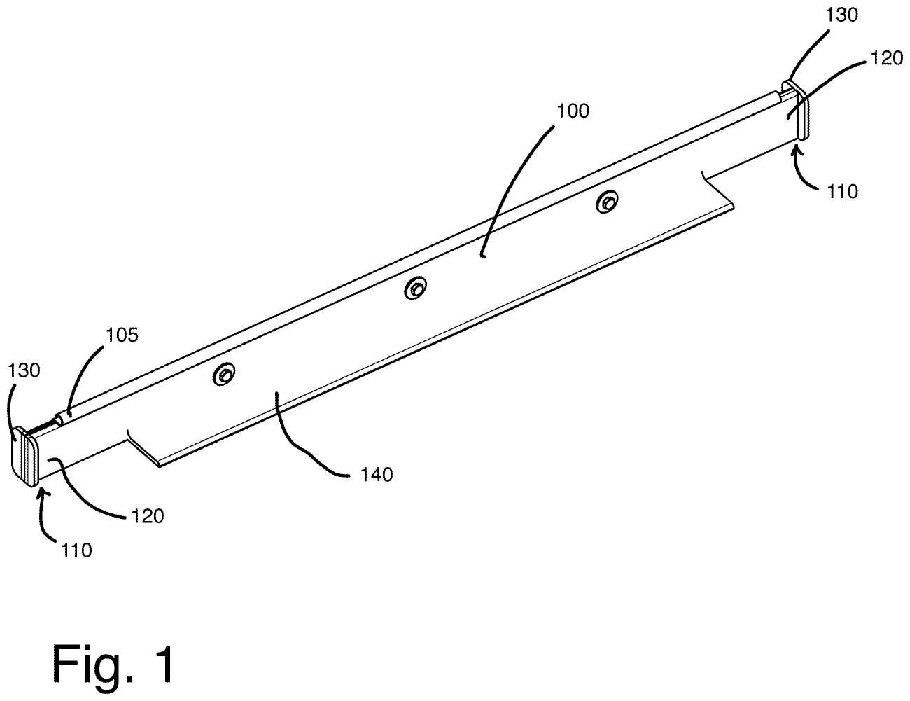

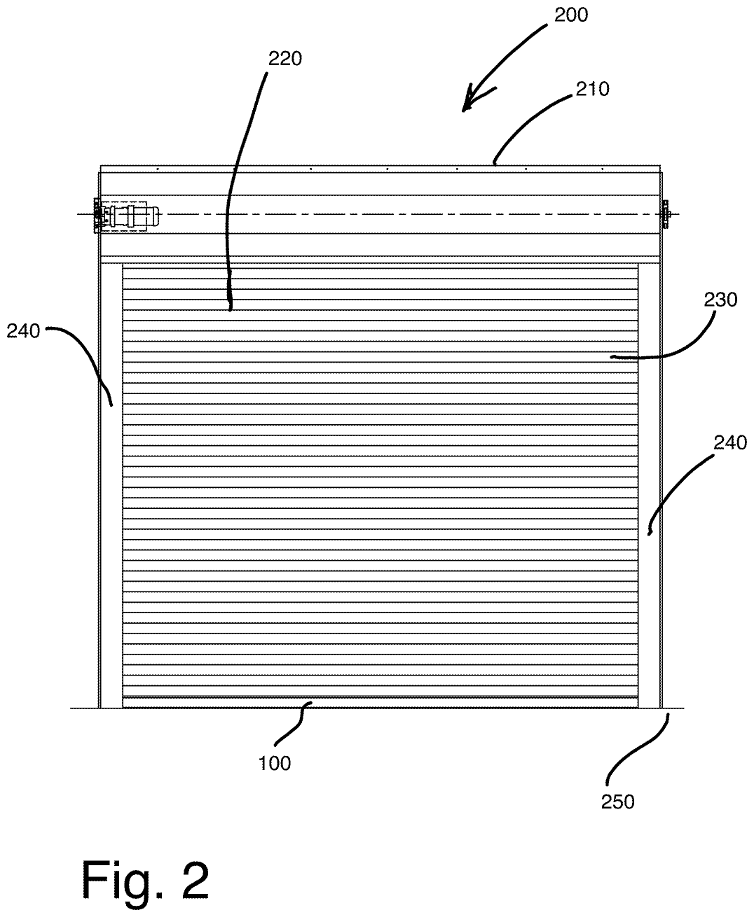

FIG. 1 is a perspective view of a locking bottom bar 100 which connects via a hooked transverse edge 105 to a bottom-most slat of a rolling door formed of a number of interconnected elongate slats (see FIG. 2). The bottom bar 100 is elongate and has anchors 110 extending from the lateral ends thereof, e.g., a wide member on each end configured as a sideways T-shaped member. In implementations, each of the anchors 110 may have a lateral portion 120 which extends laterally, i.e., in a length-wise (longitudinal) direction of the bottom bar 100, and a transverse portion 130 at a distal end of the lateral portion 120 which extends perpendicularly to the lateral portion 120. In some cases, as in the example depicted, the lateral portions 120 may be substantially in the form of an extension of the main body of the bottom bar—having a similar cross-sectional shape and size. In implementations, the anchors 110 may be T-shaped, with the lateral portion 120 being a planar rectangular member which is vertically oriented parallel to the deployment plane and the transverse portion 130 being a planar rectangular member which is vertically oriented and perpendicular to the deployment plane. The bottom bar 100 may have a bottom edge 140 which extends in a transverse (i.e., width) direction of the bottom bar 100 to serve as a base of the flexible door.

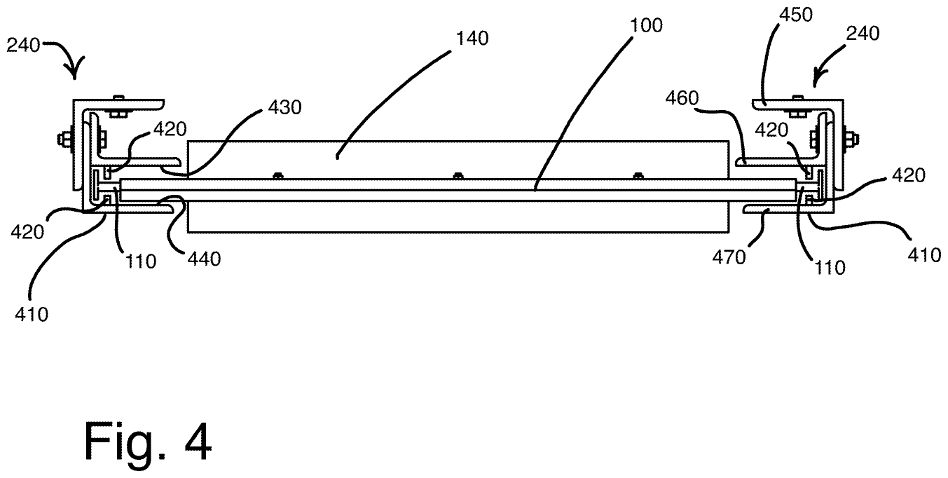

The bottom bar 100 may be described as an automatically-locking or self-locking bottom bar because each end of the bottom bar 100 has an anchor 110, e.g., a wide T-shaped portion, which aligns and fits on the outside of retaining bars (see FIG. 4) 420 in a bottom portion of the guide channels, so movement of the bottom bar becomes restricted with respect to the deployment plane of the door (e.g., movement caused by force applied to the front of the door which may disengage the door from the guide channels). This is to be distinguished from a lock which attaches the bottom bar to the floor to prevent the door from being lifted, i.e., retracted.

FIG. 2 is a front elevation view of a door assembly 200 to cover an opening of a building. The door assembly 200 includes a shutter roller 210 positioned proximate the opening and rotatable about an axis of rotation. A flexible door 220 is windable on and off the shutter roller 210 to move between a retracted position and an extended position in which at least a portion of the flexible door 220 lies in a deployment plane to at least partially cover the opening of the building. The flexible door 220 is formed by a number of elongate slats 230 which rotatably interconnect along transverse edges thereof. A pair of guide channels 240 receive the respective lateral edges of the flexible door 220 at opposing sides of the opening. Each of the elongate slats 230 has two lateral ends to form respective lateral edges of the flexible door 220, which are not visible in the view of FIG. 2 because they lie within the guide channels 240.

FIG. 2 depicts the rolling door 220 in a fully-extended closed position with interlocking horizontal slats 230 arranged between the two guide channels 240, e.g., side guide assemblies, and the bottom bar 100 in contact with the ground 250 (e.g., floor of the building). In the fully deployed and extended position, the leading edge of the door 220, i.e., bottom bar 100, sits parallel with and flush on the ground 250. As noted above, the door 220 has lateral edges which are guided along the guide channels 240 disposed along the right-side edge and left-side edge of the doorway (i.e., opening). The guide channels 240 act as a guide during deployment of the flexible door 220 and allow the door 220 to be deployed within a “plane of deployment” containing both guide channels 240.

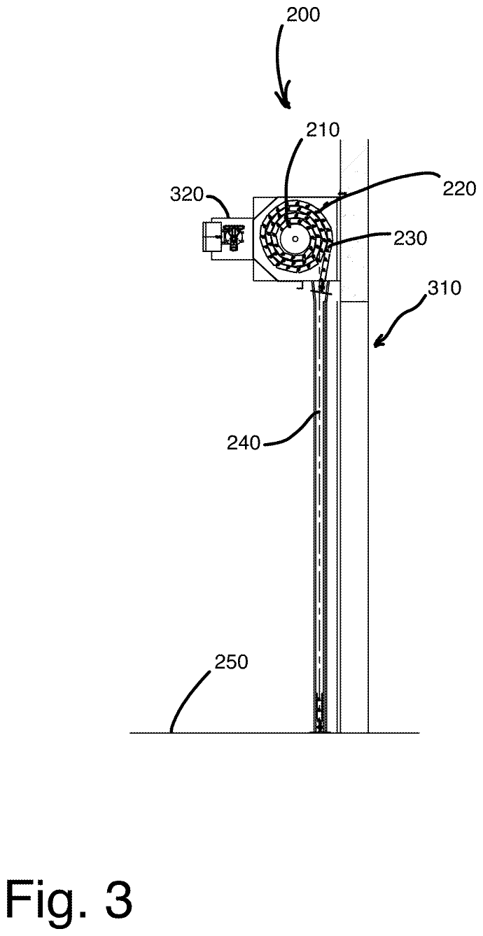

FIG. 3 shows a side sectional view of the rolling door 220 with the shutter roll 210 arranged within a housing 215 that is positioned in an opening 310. As explained above, the flexible door 220 may be formed of interconnecting horizontal slats 230 having each end secured in a respective guide channel 240 (only one of which is visible). The door 220, in the open position, is wrapped about the shutter roller 210 and can be fully deployed, to reach the closed position, by following the guide channels 240 until the bottom of the door, i.e., the bottom bar 100, reaches the floor 250. In implementations, the door assembly 200 may include a drive mechanism 320, e.g., an electric motor, to rotate the shutter roller 210 about the axis of rotation. Alternatively, a hand-operated drive mechanism can be used.

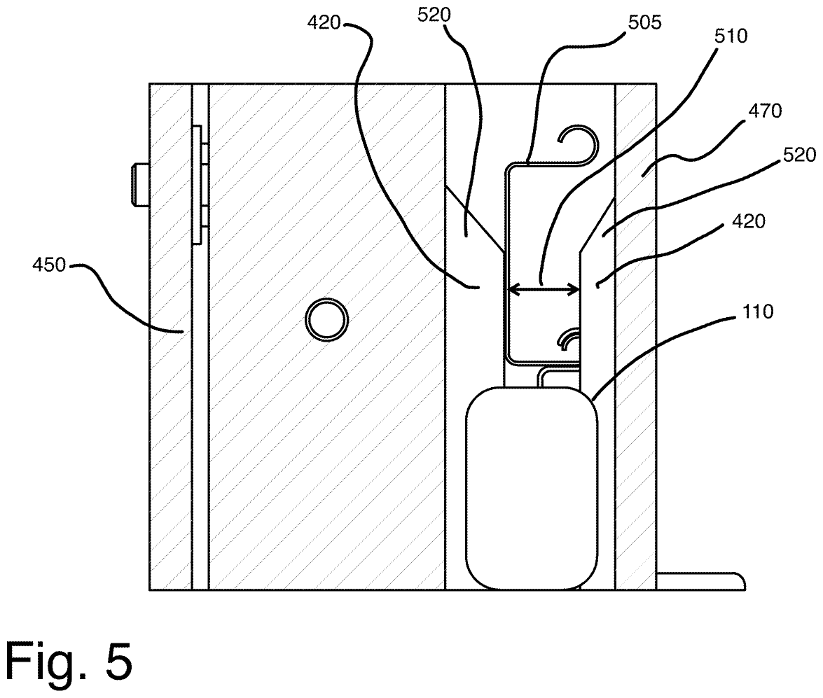

FIG. 4 is a top plan view of the locking bottom bar 100, which is connected to a bottom-most slat of the elongate slats 230 of the flexible door 220 (see FIG. 2), and which has anchors 110 extending from the lateral ends thereof (the slats of the flexible door are not depicted here for the sake of clarity). A pair of guide channels 240 receives the respective lateral edges of the flexible door 220 (not depicted here for the sake of clarity) at opposing sides of the opening 310 in which the door 220 is installed. The anchors 110 of the bottom bar 100 extend beyond the respective lateral edges of the flexible door 220. Each guide channel 240 has a reduced width portion 410 in a bottom portion thereof (i.e., the portion of the guide channel 240 nearest the floor) to receive a respective one of the anchors 110 when the bottom bar 100 passes into the bottom portion of the pair of guide channels 240. The reduced width portion 410 is laterally spaced from a lateral end of each guide channel 240 so that the respective anchor 110 is locked (i.e., trapped or constrained) in each guide channel 240. In implementations, each guide channel 240 may include a pair of retaining bars 420 in the bottom portion 245 extending from opposing inner side walls (430 and 440) thereof, respective opposing inner edges of the retaining bars 420 having a gap therebetween to form the reduced width portion 410, as described in further detail below with respect to FIG. 5.

Each of the anchors 110 may have a lateral portion extending laterally and a transverse portion at a distal end of the lateral portion and extending perpendicularly to the lateral portion (see FIG. 1). Each of the anchors 110 may be T-shaped, as in the example depicted, with the lateral portion being a planar rectangular member which is vertically oriented parallel to the deployment plane and with the transverse portion being a planar rectangular member which is vertically oriented and perpendicular to the deployment plane.

In implementations, the reduced width portion 410 of each guide channel 240 may receive the lateral portion of the respective one of the anchors 110 when the bottom bar 100 passes into the bottom portion of the pair of guide channels 240. The reduced width portion 410 may be sized and positioned so that the transverse portion of the respective one of the anchors 110 cannot pass through the reduced width portion 410 (i.e., the gap between the retaining bars 420) in a lateral direction, thereby locking the respective anchor 110 in each said guide channel 240.

In implementations, each guide channel 240 may include a first elongate angle member 450 to attach to the building, e.g., on opposing sides of an opening 310 in the building which is to be covered by the door assembly 200. Each guide channel 240 may further include a second elongate angle member 460 to attach to the first elongate angle member 450 (possibly with an intervening structural element, as in the example depicted) to form the inner wall 430 of each guide channel 240 and a third elongate angle member 470 to attach to the first elongate angle member 450 to form an outer wall 440 of each said guide channel 240.

In implementations, the lateral edges of each of the curtain slats remain within a portion of a channel formed by an inner guide angle (e.g., second elongate angle member 460) and an outer guide angle (e.g., third elongate angle member 470) when the bottom bar 100 is in contact with the ground. As the bottom bar 100 approaches contact with the ground, the bottom bar anchors 110 (e.g., T-shaped members) align with, and are constrained by, the bottom bar retaining (i.e., locking) bars 420.

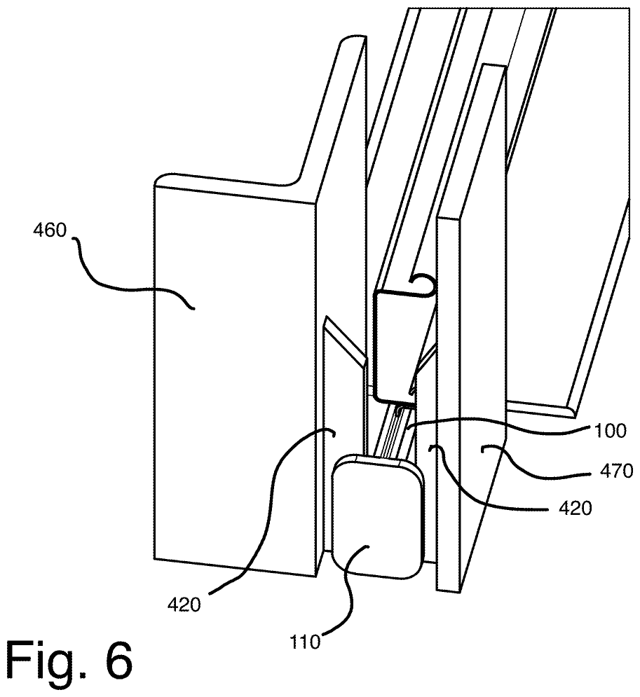

FIG. 5 is a side sectional view of the locking bottom bar 100, which is connected to a bottom-most slat 505 of the elongate slats of the flexible door 220, and which has anchors 110 extending from the lateral ends thereof (the remaining slats of the flexible door are not depicted here for the sake of clarity). FIG. 6 is an axonometric view of the locking bottom bar of FIG. 5.

As explained above, each guide channel 240 may include one or more retaining bars 420 in the bottom portion extending from respective opposing inner side walls (see FIGS. 4, 430 and 440) thereof to form the reduced width portion 410. In implementations, each guide channel 240 may include a pair of retaining bars 420 in the bottom portion extending from opposing inner side walls (430 and 440) thereof, with the respective opposing inner edges of the retaining bars 420 having a gap 510 therebetween to form the reduced width portion 410. The pair of retaining bars 420 of each guide channel 240 may have upper edges 520 which are angled toward the gap 510 to direct the lateral portion of the respective one of the anchors 110 into the reduced width portion 410 as the bottom bar 100 passes into the bottom portion of the pair of guide channels 240.

In implementations, the one or more retaining bars 420 may have a height which is between about a height of the transverse portions of the anchors 110 and about four times the height of the transverse portions of the anchors 110. In implementations, the one or more retaining bars 420 have a height which is between about two times the height of the transverse portions of the anchors 110 and about three times the height of the transverse portions of the anchors 110.

In implementations, the bottom bar anchors 110 (e.g., T-members) and curtain slats 230 remain within the outer guide angle 470 and inner guide angle 460, but when approaching the ground and the bottom bar retaining bars 420, only the T-shaped members, i.e., anchors 110, align and fit on the outside of the retaining bars 420 (in a lateral direction) and movement, particularly inward movement of the door, becomes restricted. In the example depicted, the bottom bar retaining bars 420 do not extend the entire length of the guide channels 240 and are slightly longer (i.e., greater in height) than the bottom bar T-shaped members, i.e., anchors 110, to create the automatic locking mechanism portion of the guide channels 240.

The various embodiments described above can be combined and/or modified to provide further embodiments in light of the above-detailed description, including the material incorporated by reference. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

What is claimed is:

1. A door assembly for an opening of a building, the door assembly comprising:
a shutter roller positioned proximate the opening and rotatable about an axis of rotation;
a flexible door windable on and off the shutter roller to move between a retracted position and an extended position in which at least a portion of the flexible door lies in a deployment plane to at least partially cover the opening of the building, the flexible door comprising:
a plurality of elongate slats which rotatably interconnect along transverse edges thereof, each of the plurality of elongate slats having lateral ends to form respective lateral edges of the flexible door; and
an elongate bottom bar to connect to a bottom-most slat of the plurality of elongate slats, the bottom bar having anchors extending from the lateral ends thereof, the anchors extending beyond the respective lateral edges of the flexible door; and
a pair of guide channels to receive the respective lateral edges of the flexible door at opposing sides of the opening, each guide channel having a reduced width portion in a bottom portion thereof to receive a respective one of the anchors when the bottom bar passes into the bottom portion of the pair of guide channels, the reduced width portion being laterally spaced from a lateral end of each said guide channel so that the respective anchor is locked in each said guide channel.

2. The door assembly of claim 1, further comprising a drive mechanism to rotate the shutter roller about the axis of rotation.

3. The door assembly of claim 1, wherein each of the anchors has a lateral portion extending laterally and a transverse portion at a distal end of the lateral portion and extending perpendicularly to the lateral portion.

4. The door assembly of claim 3, wherein each of the anchors is T-shaped, with the lateral portion being a planar rectangular member which is vertically oriented parallel to the deployment plane and the transverse portion being a planar rectangular member which is vertically oriented perpendicular to the deployment plane.

5. The door assembly of claim 3, the reduced width portion receives the lateral portion of the respective one of the anchors when the bottom bar passes into the bottom portion of the pair of guide channels, the reduced width portion being sized and positioned so that the transverse portion of the respective one of the anchors cannot pass through the reduced width portion in a lateral direction, thereby locking the respective anchor in each said guide channel.

6. The door assembly of claim 1, wherein each said guide channel includes one or more retaining bars in the bottom portion extending from respective opposing inner side walls thereof to form the reduced width portion.

7. The door assembly of claim 6, wherein the one or more retaining bars have a height which is between about a height of the transverse portions of the anchors and about four times the height of the transverse portions of the anchors.

8. The door assembly of claim 7, wherein the one or more retaining bars have a height which is between about two times the height of the transverse portions of the anchors and about three times the height of the transverse portions of the anchors.

9. The door assembly of claim 1, wherein each said guide channel includes a pair of retaining bars in the bottom portion extending from opposing inner side walls thereof, respective opposing inner edges of the retaining bars having a gap therebetween to form the reduced width portion.

10. The door assembly of claim 9, wherein the pair of retaining bars of each said guide channel have upper edges which are angled toward the gap to direct the lateral portion of the respective one of the anchors into the reduced width portion as the bottom bar passes into the bottom portion of the pair of guide channels.

11. The door assembly of claim 1, wherein each said guide channel comprises:
a first elongate angle to attach to the building;
a second elongate angle to attach to the first elongate angle to form an inner wall of each said guide channel; and
a third elongate angle to attach to the first elongate angle to form an outer wall of each said guide channel.

12. A flexible door windable on and off a shutter roller to move between a retracted position and an extended position in which at least a portion of the flexible door lies in a deployment plane to at least partially cover an opening of a building, the opening having a pair of guide channels at opposing sides thereof, each guide channel having a reduced width portion in a bottom portion thereof, the reduced width portion being laterally spaced from a lateral end of each said guide channel, the flexible door comprising:
a plurality of elongate slats which rotatably interconnect along transverse edges thereof, each of the plurality of elongate slats having lateral ends to form respective lateral edges of the flexible door, the lateral edges adapted to be received in the pair of guide channels; and
an elongate bottom bar to connect to a bottom-most slat of the plurality of elongate slats, the bottom bar having anchors extending from the lateral ends thereof, the anchors extending beyond the respective lateral edges of the flexible door, the anchors adapted to be received in the reduced width portions of the guide channels when the bottom bar passes into the bottom portion of the pair of guide channels so that the anchors are locked in the guide channel.

13. The flexible door of claim 12, wherein each of the anchors has a lateral portion extending laterally and a transverse portion at a distal end of the lateral portion and extending perpendicularly to the lateral portion.

14. The flexible door of claim 13, wherein each of the anchors is T-shaped, with the lateral portion being a planar rectangular member which is vertically oriented parallel to the deployment plane and the transverse portion being a planar rectangular member which is vertically oriented perpendicular to the deployment plane.

15. The flexible door of claim 13, wherein the lateral portion of each of the anchors is received in the reduced width portion of the respective guide channel when the bottom bar passes into the bottom portion of the pair of guide channels, the transverse portion of each of the anchors being sized and positioned so that the transverse portion cannot pass through the reduced width portion of the respective guide channel in a lateral direction, thereby locking each of the anchors in the respective guide channel.

16. A bottom bar to connect to a flexible door windable on and off a shutter roller to move between a retracted position and an extended position in which at least a portion of the flexible door lies in a deployment plane to at least partially cover an opening of a building, the opening having a pair of guide channels at opposing sides thereof, each guide channel having a reduced width portion in a bottom portion thereof, the reduced width portion being laterally spaced from a lateral end of each said guide channel, the flexible door comprising a plurality of elongate slats which rotatably interconnect along transverse edges thereof, each of the plurality of elongate slats having lateral ends to form respective lateral edges of the flexible door, the lateral edges adapted to be received in the pair of guide channels, the elongate bottom bar comprising:
an elongate body;
a hooked transverse edge on an upper surface of the elongate body to rotatably connect to a bottom-most slat of the plurality of elongate slats of the flexible door; and
anchors extending from lateral ends of the body, the anchors extending beyond the respective lateral edges of the flexible door, the anchors adapted to be received in the reduced width portions of the guide channels when the bottom bar passes into the bottom portion of the pair of guide channels so that the anchors are locked in the guide channel.

17. The bottom bar of claim 16, wherein each of the anchors has a lateral portion extending laterally and a transverse portion at a distal end of the lateral portion and extending perpendicularly to the lateral portion.

18. The bottom bar of claim 17, wherein each of the anchors is T-shaped, with the lateral portion being a planar rectangular member which is vertically oriented parallel to the deployment plane and the transverse portion being a planar rectangular member which is vertically oriented perpendicular to the deployment plane.

19. The bottom bar of claim 17, wherein the lateral portion of each of the anchors is received in the reduced width portion of the respective guide channel when the bottom bar passes into the bottom portion of the pair of guide channels, the transverse portion of each of the anchors being sized and positioned so that the transverse portion cannot pass through the reduced width portion of the respective guide channel in a lateral direction, thereby locking each of the anchors in the respective guide channel.
